(19) United States
(12) Patent Application Publication
(10) Pub. No.: US 2014/0083547 A1
(43) Pub. Date: Mar. 27, 2014

(54) EASILY DISTINGUISHABLE INDUSTRIAL AIR TUBE

(71) Applicant: In Soo Hwang, Seoul (KR)

(72) Inventor: In Soo Hwang, Seoul (KR)

(21) Appl. No.: 14/005,886

(22) PCT Filed: Feb. 28, 2012
(86) PCT No.: PCT/KR2012/001479

§ 371 Date: Sep. 18, 2013

(30) Foreign Application Priority Data
Mar. 23, 2011 (KR) 20-2011-0002410

(51) Int. Cl. F16L 55/00

(52) U.S. Cl. CPC F16L 55/00
USPC 138/104

(57) ABSTRACT

The present device relates to an easily distinguishable industrial air tube on which a standard-displaying part is formed on a surface of each air tube to easily distinguish the standard of the air tube, to thereby improve convenience in use. For this purpose, an air tube for pneumatic, painting, and piping applications used in various industrial settings includes a standard-displaying part (20) having a plurality of display lines (21) for displaying the standards for the outer diameter, thickness, and material of the air tube (10) such that the standards of each air tube (10) are displayed on an outer surface of the air tube (10) in order to easily distinguish each air tube.

### CROSS-REFERENCE TO RELATED APPLICATION

This application claims the benefit of Korean Patent Application No. 20-2011-0002410, filed on Mar. 23, 2011 in the Korean Intellectual Property Office, the disclosure of which is incorporated herein by reference.

### TECHNICAL FIELD

The present invention relates to an easily distinguishable industrial air tube, and more particularly, to an easily distinguishable industrial air tube on the surface of which a specification indicator is provided such that air tubes having the same specification can be easily distinguished, whereby ease in use can be improved.

### BACKGROUND ART

In general, an air tube is generally made by extruding synthetic resin into a tubular shape such that air can pass through the inside of the tube.

Such air tubes are widely used at a variety of industrial sites, such as hydraulic or pneumatic paining equipment or a vehicular or medical application.

In addition, air tubes are given different specifications, such as a size, thickness or material, depending on their uses.

However, it is difficult to distinguish the specifications of related-art air tubes since no specifications are marked on air tubes. In particular, when air tubes have the same size and different uses, workers must inspect every air tube in order to distinguish its specification, which is annoying. There is also a problem in that a long time is consumed to distinguish the specifications of air tubes, thereby lowering workability.

### DISCLOSURE

### Technical Problem

The present invention has been made to solve the foregoing problems with the related art, and therefore an object of the present invention is to provide an easily distinguishable industrial air tube on the surface of which a specification indicator is provided with lines having different colors, thicknesses and types such that a variety of industrial air tubes can be easily distinguished whether or not they have the same specification and use. This allows workers to easily distinguish the specification of each air tube, thereby maximizing the ease and efficiency of the operation.

### Technical Solution

According to the present invention for realizing the foregoing object, a specification indicator is provided on the outer surface of a variety of industrial air tubes such that the specifications of the air tubes can be distinguished. The specification indicator has a plurality of indicator lines which indicate the size of the outer diameter, thickness and material of each air tube.

In addition, in the air tube according to the present invention, a plurality of indicator lines which are marked with a color, a line thickness and a line type is formed around the outer surface of the air tube such that the specification of the air tube can be indicated.

Furthermore, as an alternative of the air tube according to the present invention, identification codes are provided on the surface of the air tube such that the specification of the air tube can be indicated and the air tube can be distinguished.

### Advantageous Effects

According to the present invention as set forth above, specification indicators including a plurality of indicator lines having different thicknesses or colors are provided on the outer surface of air tubes which are used at a variety of industrial sites, such that air tubes can be easily distinguished depending on their specifications. There is an effect in that the ease and workability of the operation can be maximized.

### DESCRIPTION OF DRAWINGS

FIG. 1 is a perspective view showing part of an industrial air tube according to the present invention;

FIG. 2 is a perspective view showing another example of the industrial air tube according to the present invention; and

FIG. 3 and FIG. 4 are perspective views showing other examples of the industrial air tube according to the present invention.

### MODE FOR INVENTION

Reference will now be made in detail to embodiments of the present invention, which are illustrated in the accompanying drawings and described below.

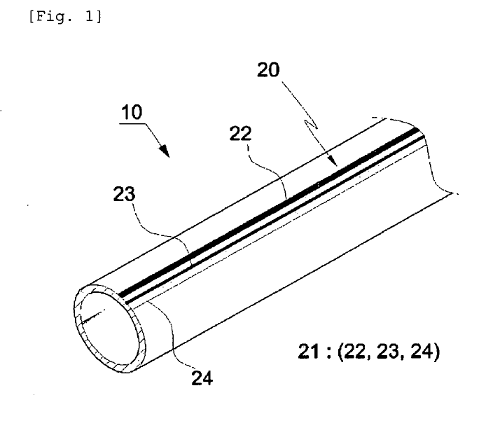

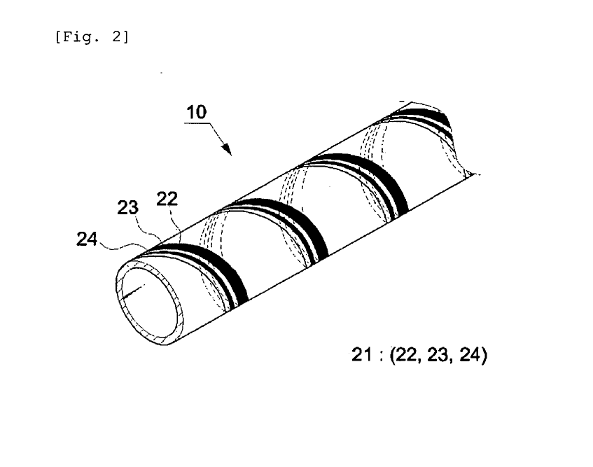

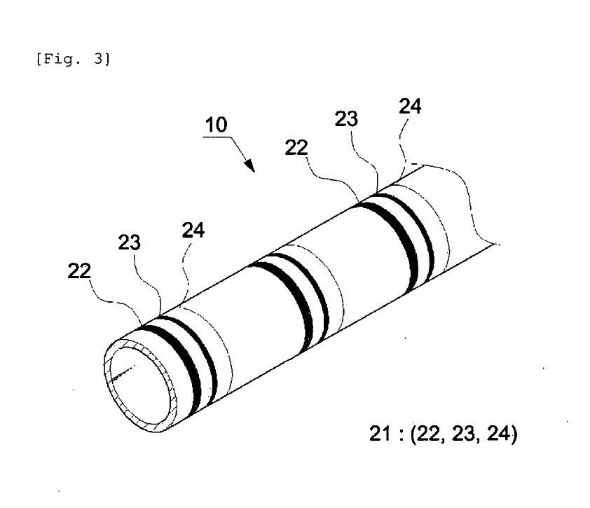

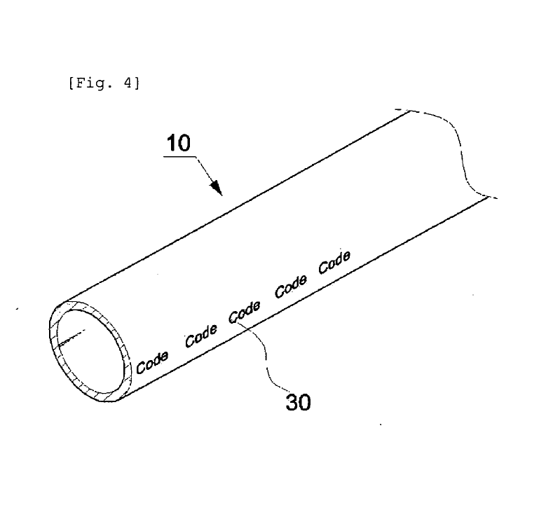

FIG. 1 is a perspective view showing part of an industrial air tube according to the present invention, FIG. 2 is a perspective view showing another example of the industrial air tube according to the present invention, and FIG. 3 and FIG. 4 are perspective views showing other examples of the industrial air tube according to the present invention.

As shown in FIG. 1 to FIG. 3, the present invention provides an air tube that is used for pneumatic, painting and piping applications at a variety of industrial sites. A specification indicator 20 is provided on the outer surface of the air tube 10 such that a plurality of air tubes 10 can be easily distinguished such that they have the same specification.

The specification indicator 20 has a plurality of indicator lines 21 thereon. The indicator lines 21 are linearly marked such that they can indicate the specification of the air tube 10.

In addition, the indicator lines 21 include a first indicator line 22 which indicates the size of the outer diameter of the air tube 10, a second indicator line 23 which indicates the thickness of the air tube 10, and a third indicator line 24 which indicates the material of the air tube 10.

Here, the first, second and third indicator lines 22, 23 and 24 are provided with different line thicknesses such that the size of the outer diameter, thickness and the material of the air tube 10 can be easily distinguished.

In addition, the first, second and third indicator lines 22, 23 and 24 have different colors or line types such that the size of the outer diameter, thickness and the material of the air tube 10 can be easily distinguished.

Furthermore, it is preferred that the first, second and third indicator lines 22, 23 and 24 be continuously marked on the surface of the air tube 10.

The indicator lines 21 are formed as straight lines that extend on the surface of the air tube (10). As an alternative, as shown in FIG. 2, the indicator lines 21 are formed as spiral lines. More preferably, indicator lines 21 continue in a variety of shapes such as a curve or a waveform.

In addition, the specification indicator 20 is painted with a noctilucent material such that the air tube 10 can be easily distinguished at night.

As shown in FIG. 3, in the air tube 10 according to the present invention, the first, second and third indicator lines 22, 23 and 24 are formed around the outer surface of the air tube 10 such that they can indicate the specification of the air tube 10.

The first, second and third indicator lines 22, 23 and 24 are provided with different colors, different line thickness and/or different line types such that the size of the outer diameter, thickness and the material of the specification of the air tube 10 can be easily distinguished.

In addition, it is preferred that the first, second and third indicator lines 22, 23 and 24 be repeatedly provided on the air tube 10.

As shown in FIG. 4, the air tube 10 according to the present invention has identification codes 30 on the surface such that the specification of the air tube 10 can be indicated.

Here, it is preferred that the identification codes 30 include numbers or letters that are repeatedly marked.

A description will be give below of the operating state of the air tube having the above-described configuration according to the present invention.

Since the specification indicator 20 with which the air tube 10 can be distinguished is provided on the surface of the air tube 10, air tubes 10 having the same size can be easily distinguished by the specification indicator 20 even though a variety of air tubes 10 are mixed.

In addition, the specification indicator 20 includes the first, second and third indicator lines 22, 23 and 24 that indicate the size of the outer diameter, thickness and material of the air tube 10, and the first, second and third indicator lines 22, 23 and 24 are provided with different thicknesses, line types and colors, such that the specification of each air tube 10 can be more easily distinguished.

Since at least one of the first, second and third indicator lines 22, 23 and 24 or the identification codes 30 consisting of numbers or letters is formed around the outer surface of the air tube 10 according to the present invention, the identification mark of the air tube 10 can be varied depending on the type and use of the air tube 10, thereby increasing the convenience of the user. In addition, such air tubes have a variety of specifications, and workers can conveniently use the air tubes in works.

The present invention is not limited to the foregoing certain embodiment. Obviously many modifications are possible to a person having ordinary skill in the art without departing from the scope of the present invention defined in the appended claims, and such modifications shall fall within the scope of the claims.

<Description of the Reference Numerals in the Drawings>

| | |
|---|---|
| 10: air tube | 20: specification indicator |
| 21: indicator line | 22: first indicator line |
| 23: second indicator line | 24: third indicator line |
| 30: identification code | |

1. An easily distinguishable industrial air tube used for a pneumatic, painting or piping application at a variety of industrial sites, comprising a specification indicator (20) provided on an outer surface of the air tube (10) such that a specification of the air tube (10) is distinguishable, wherein the specification indicator (20) has a plurality of indicator lines (21) which are linearly marked in order to indicate the specification of the air tube (10).

2. (canceled)

3. (canceled)

4. The easily distinguishable industrial air tube of claim 1, wherein first, second and third indicator lines (22, 23, 24) are repeatedly formed on the surface of the air tube (10).

5. The easily distinguishable industrial air tube of claim 4, wherein the first, second and third indicator lines (22, 23, 24) are marked with one selected from among a color, a line thickness and a line type such that the size of the outer diameter, thickness and the material of the air tube (10) is easily distinguishable.

6. (canceled)

7. (canceled)
